(19) United States
(12) Patent Application Publication
(10) Pub. No.: US 2020/0056127 A1
(43) Pub. Date: Feb. 20, 2020

(54) SOLVENT SYSTEMS AND METHODS OF USE THEREOF

(71) Applicant: ETHICAL SOLUTIONS, LLC, South Windsor, CT (US)

(72) Inventors: DANIEL J. SOCCI, West Hartford, CT (US); JENNIFER L. HOLCOMB, Marlborough, CT (US)

(73) Assignee: ETHICAL SOLUTIONS, LLC, SOUTH WINDSOR, CT (US)

(21) Appl. No.: 16/662,245

(22) Filed: Oct. 24, 2019

Related U.S. Application Data
(63) Continuation of application No. PCT/US2018/028079, filed on Apr. 18, 2018.
(60) Provisional application No. 62/489,762, filed on Apr. 25, 2017.

(51) Int. Cl. C11D 7/50; C09D 7/20; C11D 7/26

(52) U.S. Cl. CPC C11D 7/5027; C11D 7/266; C11D 7/5022; C09D 7/20

(57) ABSTRACT

A cleaning composition comprising a blend of at least one C₁-C₄ ester of a C₁₆-C₂₀ fatty acid component, at least one terpene hydrocarbon component, and optionally at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F. A method of cleaning a surface of a substrate comprising applying the cleaning composition to a substrate surface having an undesirable residue thereupon, and removing the undesirable residue from the substrate surface. The blend may be biodegradable, and has no ozone depleting compounds, no hazardous air pollutants, and no carcinogens.

### BACKGROUND OF THE DISCLOSURE

### 1. Field of the Disclosure

The present disclosure relates to solvent systems, in particular, solvent systems having at least one fatty acid ester component and at least one terpene hydrocarbon component. The present disclosure also relates to a method of cleaning a surface of a substrate (e.g., surface of furniture, equipment, buildings, walls, vehicles, bridges, and storage tanks) with the solvent systems. The solvent systems are biodegradable, and have no ozone depleting compounds, no hazardous air pollutants, and no carcinogens.

### 2. Description of the Related Art

Solvents make up a very broad and important segment of the chemical industry. Solvents are commonly used both in final products such as cleaners, polishes, pesticides, dyes, coatings, inks, and the like, and for the manufacturing of various products and chemical substances.

Important properties of solvents include the ability to dissolve other materials (or solvency), their purity and/or consistent composition, evaporation characteristics (including vapor pressure and non-volatile residue), adverse effects on humans (toxicity), adverse effects on the environment (biodegradability, ozone depletion), combustibility (flash point), availability, and cost. Because of their potential to damage both humans and the environment, solvents are the subject of many regulations.

Many solvents are, or include, volatile organic compounds (VOC's), which are organic chemical compounds that have sufficiently high vapor pressures under normal conditions to significantly vaporize and enter the atmosphere.

VOC's participate in reactions that result in tropospheric ozone formation (and smog). Further, high concentrations of VOC's have been associated with various health problems. Because of their negative effects on the environment and human wellbeing, such compounds are the subject of numerous regulations worldwide. Such regulations apply to paints, coating compositions, cleaning compositions, and other compositions comprising solvents.

“Green” solvents, such as certain alcohols, acetates, esters, and the like, are regarded as such because of their sources of origin (non-petroleum based) and the fact that they biodegrade readily after use without environmental damage. All solvents are classified as VOC's due to their photo-reactive qualities and hazardous air pollutant qualities. They are further sub-classified based upon their vapor pressures, boiling points and flash points. The flash point is important because it is the point at which the liquid becomes a volatile vapor, mixes with oxygen and thereby acquires its most combustible or flammable state.

The more flammable a solvent, the more restrictions exist on its use. Manufacturers that utilize solvents must handle the more volatile liquids more carefully and have to address issues involving atmospheric volatility, shelf life and worker health concerns from prolonged exposure to these chemicals. Green solvents are usually more costly than petroleum based solvents and may be less effective as solvents than those based on petroleum hydrocarbon stock.

There is a need for cleaning compositions which do not contain VOC's in appreciable quantities. There is also a need for cleaning compositions having solvent systems with desired flash points. There is further a need for cleaning compositions having desired cleansing power. In particular, there is a need for new solvent systems that are biodegradable, safe, low VOCs, and high flash points. It would be desirable to expand the range of potential uses for and improve the overall solvency properties of the green solvents without substantially increasing costs associated with the potential uses.

### SUMMARY OF THE DISCLOSURE

The present disclosure relates to solvent systems, in particular, solvent systems having at least one fatty acid ester component and at least one terpene hydrocarbon component. The present disclosure also relates to a method of cleaning a surface of a substrate (e.g., surface of furniture, equipment, buildings, walls, vehicles, bridges, and storage tanks) with the solvent systems. The solvent systems are biodegradable, and have no ozone depleting compounds, no hazardous air pollutants, and no carcinogens.

The present disclosure relates in part to a composition comprising a blend of at least one C₁-C₄ ester of a C₁₆-C₂₀ fatty acid component, and at least one terpene hydrocarbon component (e.g., a pure gum turpentine, an oil of turpentine, or mixtures thereof). The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the composition. The weight percent ratio is such that the composition has a flash point greater than about 118° F.

The present disclosure also relates in part to a composition comprising a blend of at least one C₁-C₄ ester of a C₁₆-C₂₀ fatty acid component, at least one terpene hydrocarbon component (e.g., a pure gum turpentine, an oil of turpentine, or mixtures thereof), and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the composition. The weight percent ratio is such that the composition has a flash point greater than about 118° F. The blend, when mixed with water, forms an emulsion.

The present disclosure further relates in part to a method of cleaning a surface of a substrate. The method comprises applying a cleaning composition comprising a solvent blend to a substrate surface having an undesirable residue thereupon, and removing the undesirable residue from the substrate surface. The solvent blend comprises at least one C₁-C₄ ester of a C₁₆-C₂₀ fatty acid component and at least one terpene hydrocarbon component (e.g., a pure gum turpentine, an oil of turpentine, or mixtures thereof). The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the solvent blend. The weight percent ratio is such that the solvent blend has a flash point greater than about 118° F.

The present disclosure yet further relates in part to a method of cleaning a surface of a substrate. The method comprises applying a cleaning composition comprising a solvent blend to a substrate surface having an undesirable residue thereupon, and removing the undesirable residue from the substrate surface. The solvent blend, when mixed with water, forms an emulsion. The solvent blend comprises at least one C₁-C₄ ester of a C₁₆-C₂₀ fatty acid component, at least one terpene hydrocarbon component (e.g., a pure gum turpentine, an oil of turpentine, or mixtures thereof), and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the solvent blend. The weight percent ratio is such that the solvent blend has a flash point greater than about 118° F.

The present disclosure also relates in part to a cleaning composition comprising a blend of at least one C₁-C₄ ester of a C₁₆-C₂₀ fatty acid component, and at least one terpene hydrocarbon component (e.g., a pure gum turpentine, an oil of turpentine, or mixtures thereof). The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the cleaning composition. The weight percent ratio is such that the cleaning composition has a flash point greater than about 118° F.

The present disclosure further relates in part to a cleaning composition comprising a blend of at least one C₁-C₄ ester of a C₁₆-C₂₀ fatty acid component, at least one terpene hydrocarbon component (e.g., a pure gum turpentine, an oil of turpentine, or mixtures thereof), and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the cleaning composition. The weight percent ratio is such that the cleaning composition has a flash point greater than about 118° F. The blend, when mixed with water, forms an emulsion.

The present disclosure yet further relates in part to a method of treating an oil or gas well having a wellbore, well casing, production equipment, recovery equipment or transportation equipment. The method comprises introducing into the wellbore, well casing, production equipment, recovery equipment or transportation equipment a solvent blend. The blend comprises at least one C₁-C₄ ester of a C₁₆-C₂₀ fatty acid component and at least one terpene hydrocarbon component (e.g., a pure gum turpentine, an oil of turpentine, or mixtures thereof). The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

The present disclosure also relates in part to a method of treating an oil or gas well having a wellbore, well casing, production equipment, recovery equipment or transportation equipment. The method comprises introducing into the wellbore, well casing, production equipment, recovery equipment or transportation equipment a blend, which when mixed with water, forms an emulsion. The blend comprises a blend of at least one C₁-C₄ ester of a C₁₆-C₂₀ fatty acid component, at least one terpene hydrocarbon component (e.g., a pure gum turpentine, an oil of turpentine, or mixtures thereof), and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

These and other systems, methods, objects, features, and advantages of the present disclosure will be apparent to those skilled in the art from the following detailed description of the embodiments.

### DESCRIPTION OF THE EMBODIMENTS

Embodiments of the present disclosure are described more fully hereinafter, in which some, but not all, embodiments of the present disclosure are shown. Indeed, the present disclosure can be embodied in many different forms and should not be construed as limited to the embodiments set forth herein. Rather, these exemplary embodiments are provided so that the present disclosure satisfies applicable legal requirements. Also, like numbers refer to like elements throughout.

The solvent systems of this disclosure can be used for applications such as to clean the surface of substrates, including the surface of furniture, equipment, buildings, walls, vehicles, bridges, storage tanks, and the like.

The cleansing properties of the cleaning compositions of this disclosure are useful for cleaning and/or degreasing many substances. For example, the cleaning compositions of this disclosure can be applied to remove materials including but not limited to polar, nonpolar, inorganic, organic, and particulate materials from substrate surfaces including but not limited to metal, glass, wood, and concrete surfaces. The compositions can be applied to remove grease, oil, tar, bugs, paint, asphalt, and dirt from vehicles and other road equipment, floors, walls, and windows.

Additionally, the solvent systems of this disclosure can be used in coating systems. Illustrative coating systems include, for example, paints including oil-based paints, varnishes, lacquers, adhesives, vinyl coatings, and the like.

Further, the solvent system of this disclosure is also useful in treating oil or gas wells, and in removing hydrocarbons from a surface (e.g., a surface of production equipment, recovery equipment or transportation equipment) using the solvent systems.

The solvent systems of this disclosure provide for increased solvency, especially for materials such as waxes (e.g., paraffins), asphaltenes, and the like. The solvent systems of this disclosure exhibit flash points, generally in excess of 118° F. In addition, the solvent systems of this disclosure have low volatile organic compounds (VOCs) and may exhibit very low toxicity. Thus, the solvent systems of this disclosure are especially useful in environmentally sensitive areas as well as in areas where a high flash point is necessary. In an embodiment, the compositions and methods of this disclosure provide for increased flow, production, and/or recovery of oil and gas hydrocarbons from a subterranean formation.

The solvent systems of this disclosure contain a fatty acid ester component, a terpene hydrocarbon component, and optionally a surfactant component. When the system contains a surfactant (e.g., one or more emulsifiers), the system can be combined with water to form an oil-in-water emulsion. The emulsion may phase separate if left undisturbed, however will easily re-emulsify upon little agitation.

Suitable fatty acid esters are those C₁-C₄ esters of C₁₆-C₂₀ fatty acids including edible vegetable oils. Such oils may have a melting point of −10° C. or less. Preferred edible vegetable oils are selected from corn, coconut, mustard, palm kernel oil, neem, niger seed, olive, peanut, poppy seed, safflower, rapeseed, sesame, soybean, sunflower seed, wheat germ oil and other polyunsaturated containing oils (such as oleic acid, linoleic acid, erucic acid and linolenic acid).

The C₁₆-C₂₀ fatty acid ester may further be a mixture of oils. Edible vegetable oils containing a mixture of about 70 to about 90 weight percent oleic and linoleic acids are often preferred. Soybean oil, which is comprised principally of oleic and linoleic acids, is a preferred C₁₆-C₂₀ fatty acid. A methyl ester is the preferred C₁-C₄ group. A particularly fatty acid ester is soybean methyl ester or soy methyl ester. Soy methyl ester is obtained from the esterification of soybean oil. Such fatty acid esters are non-toxic and biodegradable.

The fatty acid ester component is used to raise the flash point in compositions of the present disclosure. In some embodiments, a lesser amount of the fatty acid ester component is required to raise the flash point of the compositions to the same temperature.

The fatty acid ester component is added to the terpene hydrocarbon component to provide a lower cost solvent than the terpene hydrocarbon component alone.

The fatty acid ester concentration in the composition may be between about 10 and about 99 percent by weight. The concentration may be greater than about 15, 20, 25, 30, 35, 40, 45, 50, 55, 60, 65, 70, 75, 80, 85, 90 or 95 by weight or less than about 95, 90, 85, 80, 75, 70, 65, 60, 55, 50, 45, 40, 35, 30, 25, 20 or 15 percent by weight. The concentration is measured by dividing the weight of the total fatty acid ester by the total weight of the composition.

The fatty acid ester component is combined with a terpene hydrocarbon component. Terpenes are a large and varied class of hydrocarbons with the molecular formula (C₅H₈)ₙ and are produced by a wide variety of plants and trees, such as conifers and pines. Terpenes are derived biosynthetically from units of isoprene, which has the molecular formula C₅H₈. The term “terpene” is sometimes used broadly to also include the terpenoids which are terpenes that have been chemically changed or modified, such as through oxidation. A terpene, as used herein, may be any hydrocarbon, natural or synthetic, formed from isoprene units. Terpenes as well as terpenoids, are the primary ingredients of the essential oils of many types of trees, plants, and flowers, including citrus fruits. Terpenes are the major components of rosin (resin) as well as turpentine produced from gum rosin (resin).

The terpenes are generally classified sequentially by the number of isoprene units they contain as hemiterpenes (one isoprene unit), monoterpenes (two isoprene units), sesquiterpenes (three isoprene units), diterpenes (four isoprene units), sesterterpenes (five isoprene units), triterpenes (six isoprene units), and tetraterpenes (eight isoprene units).

When a terpene is modified chemically, such as by oxidation or rearrangement of the carbon skeleton, the resulting compound is generally referred to as a terpenoid. Terpenes and terpenoids are typically derived from plants, trees, flowers, and other vegetation. They come in the form of liquids, solids, waxes, oils, and alcohols. Terpenes and terpenoids may be formed as acyclic, monocyclic, or polycyclic structures. Sometimes alternatively referred to as “isoprenoids”, terpenoids are derived from five-carbon isoprene units and can be classified as “modified terpenes”, where methyl groups have been moved or removed, or oxygen atoms added. Some researchers use the term terpene to include all terpenoids.

Terpenes and terpenoids in various forms have been used for centuries in fragrances due to their compatibility with other compounds and their minimal negative environmental impact. Terpineol, a terpene alcohol, has the chemical formula: C₁₀H₁₈O and is found in three isomeric forms, alpha, beta, and gamma, with beta-terpineol being non-naturally occurring. Terpenes and terpenoids have been used for other purposes, such as disinfectants, cleaning compounds, soaps, cosmetics, and colognes. They are also known to add, enhance, or mask the odor of products which might be offensive to humans or animals.

The term “terpene” is derived from the word “turpentine”. Turpentine is a volatile fluid which is distilled and refined for further commercial uses. The most common terpenes obtained from rosin (resin) distillation are the bicyclic terpenes alpha-pinene (α-pinene), beta-pinene (β-pinene), delta-3 carene (δ-3 carene), and sabinene, the monocyclic terpenes limonene and terpinolene, and smaller amounts of tricyclic sesquiterpenes longifolene, caryophyllene, and delta-cadinene. Rubber, which is a polyterpene, is one of the most widely known terpenes.

As with other plant essential oils, terpenes are major constituents of the essential oils of citrus fruits. However, they are removed before the essential oil is used for flavoring beverages and foods because they tend to produce undesirable tastes when permitted to oxidize and polymerize.

Terpene hydrocarbons are liquid distillates separated from rosin pitch or sap from conifers, pine trees, citrus, and varied vegetation. The volatile terpene hydrocarbons, Chemical Abstracts Service Number (CAS#) 8006-64-2, are non-oxygenated with the molecular formula C₁₀H₁₆. Common names include terpenes, diterpenes, pure gum turpentine (PGT), oil of turpentine (OT), and limonene.

Pure gum turpentine is a complex formulation made of a-pinene (CAS#80-56-8) 40%-55% weight, β-pinene (CAS#127-91-3) 25%-35% weight, and the balance mixed trace terpenes. Pure gum turpentine is 99.5%-100% volatile, evaporating slightly less (0.9) than the reference standard (butyl acetate (1.0)) and has a flash point of 95° F., a boiling point of 155-180° C., and a Kauri-butanol (Kb) value greater than 50 and is generally soluble in organic solvents.

Turpentine, which is also known as spirit turpentine, oil of turpentine, and wood turpentine, is obtained by the distillation of resin from trees, usually pine trees. Turpentine prepared in this manner includes mostly alpha-pinene and beta-pinene, two terpene isomers. The exact composition of turpentine may vary from batch to batch depending on the distillation conditions and the resin source.

Terpene alcohols generally have the structure of terpenes except that they include at least one hydroxyl group. A terpene alcohol, as used herein, may be any compound, natural or synthetic, formed from isoprene units and having at least one hydroxyl group. Terpene alcohols are also derived from plants, trees, flowers, and other vegetation which allows their classification as “green compounds”. Terpene alcohols are also divided into groups determined by the number of carbon atoms and repeating isoprene units. Terpene alcohols may be formed as acyclic, monocyclic, or polycyclic structures. Terpineol, a terpene alcohol, has the chemical formula: C₁₀H₁₈O and is found in three isomeric forms, alpha (α), beta (β), and gamma (γ), with β-terpineol being non-naturally occurring. Terpene alcohols have been used for many purposes, including, but not limited to, disinfectants, cleaning compounds, soaps, cosmetics, and colognes. They are also known to add to, enhance, or mask the odor of products which might be otherwise offensive to humans or animals.

A terpene, as used herein, may be any hydrocarbon, natural or synthetic, formed from isoprene units. The terpene is preferably a monoterpene formed from two isoprene units and having the molecular formula C₁₀H₁₆. Monoterpenes include, but are not limited to, dipentene, terpinolene, alpha-ocimene, beta-ocimene, myrcene, alpha-terpinene, beta-terpinene, gamma-terpinene, sabinene, alpha-thujene, beta-thujene, camphene, carene, alpha-pinene, beta-pinene, D-limonene, and L-limonene.

More preferably, the terpene hydrocarbon component is turpentine or a component of turpentine. Turpentine, as used herein, may be any distilled resin from trees, usually pine trees. Turpentine may include at least camphene, carene, alpha-pinene, and beta-pinene in varying proportions depending on the resin source and distillation process. Gum turpentine, as used herein, is generally obtained by the distillation of sap from living pine trees, and preferably steam-distilled from Pinus elliottii trees. Gum turpentine preferably includes over 90% pinene, almost half of which being beta-pinene. Wood turpentine, in contrast, is generally obtained by distillation or solvent extraction from finely chopped wood chips and generally contains 75 to 85% alpha-pinene and little or no beta-pinene.

In some embodiments, the compositions also include at least one terpenoid. Terpenoids include, but are not limited to, terpene alcohols, citral, menthol, and camphor. Terpenoids generally have a vapor pressure that is less than 0.05 mm Hg, thus complying with VOC standards. Terpene alcohols include, but are not limited to, alpha terpineol, beta terpineol, gamma terpineol, geraniol, citronellol, nerol, nerolidol, and farnesol.

Preferred terpene hydrocarbon components useful in this disclosure include, for example, pine oil, pinene, carene, menthadiene, dipentene, pine terpene, turpentine, conifer terpenes and resins, and the like.

The compositions contain about 1 to about 90 percent by total weight of the mixture (wt %) of at least one terpene hydrocarbon component. The concentration may be greater than about 5, 10, 15, 20, 25, 30, 35, 40, 45, 50, 55, 60, 65, 70, 75, 80 or 85 by weight, or less than about 85, 80, 75, 70, 65, 60, 55, 50, 45, 40, 35, 30, 25, 20, 15, 10, or 5 percent by weight. In some embodiments, the compositions contain about 40 wt % of at least one terpene and about 5 wt % of a terpene alcohol. In some embodiments, the terpene is turpentine. In some embodiments, the terpene alcohol is alpha terpineol.

A composition of the present disclosure preferably includes from about 40 to about 60 wt % of at least one terpene, and from about 40 to about 60 wt % of a fatty acid ester such that the flash point of the system is above 118° F. In some embodiments, the terpene is selected from gum turpentine, dipentene, terpinolene, limonene, alpha-pinene, beta-pinene, and any combination of these. In some embodiments, the fatty acid ester is selected from vegetable oils including corn, coconut, mustard, palm kernel oil, neem, niger seed, olive, peanut, poppy seed, safflower, rapeseed, sesame, soybean, sunflower seed, wheat germ oil and other polyunsaturated containing oils (such as oleic acid, linoleic acid, erucic acid and linolenic acid). The terpene may also improve the performance, economic gain, or the solvent efficiency of the solvent system. In some embodiments, the terpene is present in a concentration less than 55 wt % and may be as low as about 40 wt % in some embodiments.

The compositions may be any terpene system known in the art to which at least one fatty acid ester has been added to raise the flash point. Preferably, the fatty acid ester raises the flash point of the system to above 118° F. More preferably, the fatty acid ester raises the flash point of the system to above 120° F. to meet most international standards for non-flammables. More preferably, a minimum amount of fatty acid ester is used to raise the flash point to about 120° F. to 200° F. The amount of fatty acid ester is preferably in the range from about 40 to about 60 wt %.

The weight percent ratio of the at least one C₁-C₄ ester of a C₁₆-C₂₀ fatty acid component to the at least one terpene hydrocarbon component is from about 10:90 weight percent to about 99:1 weight percent, preferably from about 20:80 weight percent to about 95:5 weight percent, more preferably from about 30:70 weight percent to about 90:10 weight percent, and even more preferably about 40:60 weight percent to about 80:20 weight percent, based on the total weight of the composition. The weight percent ratio of the at least one C₁-C₄ ester of a C₁₆-C₂₀ fatty acid component to the at least one terpene hydrocarbon component may be from about 15:85 weight percent to about 95:5 weight percent, from about 20:80 weight percent to about 90:10 weight percent, from about 25:75 weight percent to about 85:15 weight percent, from about 30:70 weight percent to about 80:20 weight percent, from about 35:65 weight percent to about 75:25 weight percent, from about 40:60 weight percent to about 70:30 weight percent, from about 45:55 weight percent to about 65:35 weight percent, from about 50:50 weight percent to about 60:40 weight percent, from about 60:40 weight percent to about 50:50 weight percent, from about 65:35 weight percent to about 45:55 weight percent, from about 70:30 weight percent to about 40:60 weight percent, from about 75:25 weight percent to about 35:65 weight percent, from about 80:20 weight percent to about 30:70 weight percent, from about 85:15 weight percent to about 25:75 weight percent, from about 90:10 weight percent to about 20:80 weight percent, or from about 95:5 weight percent to about 15:85 weight percent.

The fatty acid ester may further be combined with a lactate ester. The resulting blend may be used in conjunction with the terpene hydrocarbon component. The lactic acid ester is preferably a C₁-C₄ ester of lactic acid. Exemplary C₁-C₄ alcohols for producing the lactic acid ester include methanol, ethanol, propanol, isopropanol, allyl alcohol, butanol, 3-buten-1-ol, t-butanol and sec-butanol. Such alcohols are further the preferred alcohols for producing the fatty acid esters. In a particularly preferred embodiment, the lactic acid ester is ethyl lactate. Ethyl lactate is the ester of natural lactic acid produced by fermentation of corn-derived feedstock. Like the fatty acid esters, lactic acid esters are 100% biodegradable, breaking down into carbon dioxide and water, non-toxic, and renewable.

When present, the lactic acid ester is present at about 5 to about 25 weight percent and the fatty acid ester at about 40 to about 60 weight percent of the blend. In a preferred embodiment, the weight ratio of lactic acid ester:fatty acid ester is between from about 35:65 to 65:35, preferably 50:50.

A surfactant can optionally be included in the compositions of this disclosure. The surfactant can be, for example, a nonionic surfactant selected from a fatty alcohol ethoxylate, a fatty acid ethoxylate, a fatty acid ester, a fatty acid methyl ester ethoxylate, an alkyl polyglucoside, a polyalcohol ethoxylate, a soy alkyltrimethyl ammonium chloride, a monococoate, and combinations. The nonionic surfactant can be an ethoxylated coco fatty acid, an ethoxylated coco fatty ester, an ethoxylated cocoamide, an ethoxylated castor oil, a monococoate, and combinations. The polyethylene glycol (PEG) coco fatty acids can have a range of 5 to 40 PEG groups. The Hydrophile-Lipophile Balance (HLB) range for the PEG coco fatty acid can be 10 to 19. The concentration range of this compound can be from 0.01 to 80 percent of the total surfactant in this composition. The ethoxylated plant oil-based surfactants consisting of a PEG castor oil can have a range of 2.5 to 40 PEG groups. The Hydrophile-Lipophile Balance (HLB) range for the PEG castor oil can be 2.1 to 16. The concentration range of this compound can be from 10 to 80 percent of the total surfactant in this composition. The PEG cocamide can have a range of 2 to 20 PEG groups. The Hydrophile-Lipophile Balance (HLB) range for the PEG cocamide can be 2 to 19. The concentration range of this compound can be from 10 to 80 percent of the total surfactant in this composition. The sorbitan ester based surfactants can have the following: sorbitan monooleate with an HLB of 4.8: sorbitan monolaurate with an HLB of 8.6; sorbitan monopalmitate with an HLB of 6.5; and sorbitan monostearate with an HLB of 4.7. The ethoxylated sorbitan ester based surfactants can have the following: polyoxyethylene (20) sorbitan monooleate with an HLB of 15; polyoxyethylene(20) sorbitan monopalmitate with an HLB of 15.6; polyoxyethylene(20) sorbitan monostearate with an HLB of 14.9; and polyoxyethylene(20) sorbitan monooleate with an HLB of 15.0. The surfactant can be present in a final concentration that varies from 0.01 to 50 percent, for example, from 0.05 to 5 percent by weight.

In an embodiment, the surfactant can be, for example, a nonionic surfactant selected from a fatty alcohol ethoxylate, a fatty acid ethoxylate, a fatty acid ester, a fatty acid methyl ester ethoxylate, an alkyl polyglucoside, a polyalcohol ethoxylate, a soy alkyltrimethyl ammonium chloride, a monococoate, and combinations thereof.

In another embodiment, the surfactant can be, for example, a nonionic surfactant selected from an ethoxylated coco fatty acid, an ethoxylated coco fatty ester, an ethoxylated cocoamide, an ethoxylated castor oil, a monococoate, and combinations thereof.

In a further embodiment, the surfactant can be, for example, the ethoxylated coco fatty acid can be a polyethylene glycol (PEG) coco fatty acid having a range of about 5 to about 40 PEG groups, and a Hydrophile-Lipophile Balance (HLB) range from about 10 to about 19; the ethoxylated castor oil can be a polyethylene glycol (PEG) castor oil having a range of about 2.5 to about 40 PEG groups, and a Hydrophile-Lipophile Balance (HLB) range from about 2.1 to about 16; the ethoxylated cocoamide can be a polyethylene glycol (PEG) cocamide having a range of about 2 to about 20 PEG groups, and a Hydrophile-Lipophile Balance (HLB) range from about 2 to about 19.

In a yet further embodiment, the surfactant can be, for example, the surfactant can be a sorbitan ester selected from sorbitan monooleate having a Hydrophile-Lipophile Balance (HLB) range from about 2.8 to about 8.8; sorbitan monolaurate having a Hydrophile-Lipophile Balance (HLB) range from about 4.6 to about 12.6; sorbitan monopalmitate having a Hydrophile-Lipophile Balance (HLB) range from about 2.5 to about 10.5; and sorbitan monostearate having a Hydrophile-Lipophile Balance (HLB) range from about 2.7 to about 8.7.

In another embodiment, the surfactant can be, for example, the surfactant can be an ethoxylated sorbitan ester selected from a polyethylene glycol (PEG) sorbitan monooleate having a range of about 2 to about 40 PEG groups, and having a Hydrophile-Lipophile Balance (HLB) range from about 10 to about 20; a polyethylene glycol (PEG) sorbitan monolaurate having a range of about 2 to about 40 PEG groups, and having a Hydrophile-Lipophile Balance (HLB) range from about 10 to about 20; a polyethylene glycol (PEG) sorbitan monopalmitate having a range of about 2 to about 40 PEG groups, and having a Hydrophile-Lipophile Balance (HLB) range from about 10 to about 20; and a polyethylene glycol (PEG) sorbitan monostearate having a range of about 2 to about 40 PEG groups, and having a Hydrophile-Lipophile Balance (HLB) range from about 10 to about 20.

In some embodiments, the surfactant concentration in the composition may be between about 0.01 and about 50 percent by weight. The concentration is measured by dividing the weight of the total surfactant by the total weight of the composition. The concentration may be greater than about 0.01, 0.03, 0.05, 0.1, 0.5, or 1 by weight or less than about 50, 45, 40, 35, 30, 25, 20, 15, 10, or 5 percent by weight. Relative to the non-water components, the surfactant concentration may be greater than about 5, 10, 15, or 20 percent. The concentration relative to the non-water components is determined by dividing the weight of surfactant by the total weight of the non-water components in the composition.

The solvent system may further contain thixotropic agents and pH adjusters, when needed. For instance, the solvent systems may contain between 0 to about 10 weight percent of thickener. Preferred thixotropic agents are polysaccharide derivatives having nonionic functionalities such as alkyl alcohol or ether groups. Exemplary thickeners include methylcellulose, hydroxyethyl cellulose, hydroxypropyl cellulose, hydroxypropyl methylcellulose, cornstarch, hydroxyethyl cornstarch, and hydroxypropyl cornstarch.

The solvent system may be a homogeneous liquid or gel at 0° C. It may further have a flash point in excess of 118° F., preferably in excess of 120° F., more preferably in excess of 125° F.

The solvent system can also be used as a concentrate, and as such, it can be admixed with water prior to use. The solvent system may further be emulsified prior to use.

In particular, the solvent system used in the disclosure may be in the form of an emulsion, defined as a multiphase system consisting of water, co-solvent blend, emulsifier(s), and alcohol, and is a transparent and thermodynamically stable liquid solution. Emulsions can be considered as small-scale versions of emulsions, i.e., droplet type dispersions either of oil-in-water with an average particulate size ranges in the order of about 5 to about 50 nm in drop radius. In emulsions, the average drop size grows continuously with time so that phase separation ultimately occurs. The drops of the emulsion are generally large (>0.1 microns) and often exhibit a milky or cloudy, rather than a translucent, appearance as seen in emulsions.

The emulsifying agent lowers the interfacial tension between oil and water to produce a sufficiently small droplet size, from about 3 microns to about 20 microns, preferably about 10 microns or less in diameter. The emulsifier should be capable of creating an oil-in-water emulsion upon combination with an appropriate quantity of water. Preferred emulsifiers are biodegradable and have an HLB (hydrophile-lipophile balance) value between from about 8 to about 18.

When employed, such emulsifiers may be present in the produced emulsion at a concentration in the range of about 200 ppm to about 10,000 ppm.

The emulsifiers can be anionic, nonionic, amphoteric, as well as mixtures thereof. Blends of both non-ionic and anionic emulsifiers have been found to decrease droplet size in most instances. Where such a blend is used, a preferred ratio of non-ionic to anionic emulsifier is about 5/95 to about 95/5, preferably about 50/50 to about 85/15.

Any suitable, non-toxic anionic emulsifier may be used in such blends. Preferred anionic emulsifiers include, but are not necessarily limited to those selected from alkyl sulfates, alkane sulfonates, alkyl aryl sulfonates and phosphate esters comprising about 8 to about 18 carbon atoms, preferably about 8 to about 12 carbon atoms.

Suitable anionic emulsifiers include the sodium alkyl benzene sulfonates sulfosuccinic acid esters such as sodium dioctyl sulfosuccinate, and the like. Preferred is dioctyl sulfosuccinate having an HLB value greater than about 13.

Suitable nonionic emulsifiers are those based on fatty alcohols. For instance, a preferred nonionic emulsifier is of the fatty alcohol ethoxylate type such as one having 6-mole ethoxylation on a 12-carbon alcohol. An example of a particularly suitable fatty alcohol ethoxylate is tallow alcohol ethoxylate containing 2 or 3 moles of ethylene oxide.

Further suitable as the nonionic emulsifiers are alkyl and alkylaryl polyether alcohols such as linear or branched polyoxyethylene alcohols, more preferably linear polyoxyethylene alcohols, comprising (a) from about 8 to about 30, preferably about 8 to about 20, carbon atoms, and (b) comprising about 3 to about 50 moles, most preferably about 3 to about 20 moles, ethylene oxide. Most preferred nonionic emulsifiers are linear polyoxyethylene alcohols having from about 13 to about 15 carbon atoms and comprising about 10 moles ethylene oxide. Further, preferred emulsifiers include nonylphenol ethoxylate having a HLB value of about 16 and comprising 20 ethylene oxide units per molecule, octylphenol ethoxylate having an HLB value greater than 13.5, and nonylphenol ethoxylate having a HLB value greater than 13.

In another preferred embodiment, the nonionic emulsifiers are a combination of alkylaryl ethoxylate and a polyethylene glycol (PEG) ester of fatty acids. Preferably, the alkylaryl ethoxylate is octyl, nonyl or dodecylphenol with 3 to 13 moles of ethylene oxide, while the PEG ester is of molecular weight range 200-600 with either one or two moles of unsaturated fatty acids.

Further preferred as oil-in-water emulsifiers are polyoxyethylene sorbitan monopalmitate, polyoxyethylene sorbitan monostearate, polyoxyethylene sorbitan monooleate, linear alcohol alkoxylates, alkyl ether sulfates, linear nonyl-phenols, dioxane, ethylene glycol and ethoxylated castor oils such as polyethylene glycol castor oil, dipalmitoylphosphatidylcholine (DPPC), polyoxyethylene (8.6) nonyl phenyl ether, ethylene oxide sulfonates (i.e., alkyl propoxy-ethoxysulfonate), alkyl propoxy-ethoxysulfate, alkylarylpropoxy-ethoxysulfonate and highly substituted benzene sulfonates.

Illustrative amphoteric emulsifiers suitable for present purposes are polyethoxyline amine and oxyethylated sodium salts.

While the emulsifiers outlined above cover a wide range of physical properties and provide wide ranging emulsification abilities, a balance between two quite different emulsifiers can produce a far greater effect than an intermediate emulsifier. For instance, especially desired results can be obtained by use of a fatty alcohol and dioctyl sodium sulfosuccinate.

The emulsions may further contain a sufficient amount of a relatively strong acid to lower the pH of the solvent system to about 4 or less, preferably to about 2 or less to about 3 or less, and most preferably to about 1 or less. Relatively strong acids include, but are not necessarily limited to, phosphoric acid, hydrochloric acid, sulfuric acid, nitric acid, and the like. A preferred acid is phosphoric acid.

The alcohol component of the emulsion serves as a coupling agent between the fatty acid ester/terpene blend and the emulsifier, thereby stabilizing the emulsion. Although isopropanol is presently preferred, alternative suitable alcohols include mid-range primary, secondary and tertiary alcohols with between 1 and 20 carbon atoms, such as t-butanol, n-butanol, n-pentanol, n-hexanol and 2-ethyl-hexanol. Other freeze prevention additives can additionally or alternatively be added, such as detergent range alcohols ethoxylate, ethylene glycols (EG), polyethylene glycols (PEG), propylene glycols (PG) and triethylene glycols (TEG), with triethylene glycol being presently preferred.

The emulsion preferably comprises from 0 wt % to about 15 wt % strong acid; about 10 wt % to about 70 wt %, preferably about 65 wt % emulsifier(s); from about 10 to about 50 wt % of fatty acid ester/terpene blend; from about 25 to about 45 wt. % alcohol and, the remainder, water. The emulsion may further optionally include a salt.

The addition of a salt to the solvent system reduces the amount of water needed. Among the salts that may be added are NaCl, KCl, CaCl₂, and MgCl. Others suitable salts can be formed from K, Na, Br, Cr, Cs and Bi metals.

The emulsions may be prepared by subjecting the emulsifier(s), alcohol and optional components to high intensity shear at room temperature, typically for about 5 to 10 minutes. The blend of fatty acid ester and terpene is then added and shearing is continued. Water is then added, typically after about 5 to 10 minutes. The resulting emulsion is typically colorless.

The present disclosure also relates to a method of treating an oil or gas well with the solvent systems. The present disclosure further relates to a method of removing hydrocarbons from a surface (e.g., a surface of production equipment, recovery equipment or transportation equipment) using the solvent systems.

Also, the solvent systems of this disclosure are useful in the enhancement of oil recovery and have applicability as spearhead fluids and thus may be introduced prior to the introduction of a well treatment fluid. For instance, the solvent system is useful as a spearhead fluid to remove produced hydrocarbons prior to a water control treatment. This treatment further serves to prevent breakage or emulsification of the subsequently injected water control fluid due to mixing with the produced oil.

The present disclosure provides improved efficiency in well remediation and stimulation by the introduction of a biodegradable solvent system into the wellbore. The solvent system has applicability in the removal of pipe dope and hydrocarbons, oil based, and synthetic oil based drilling muds and the dispersement of paraffins and asphaltenes. It may further be used as a displacement spacer system, either as a single spacer or as a multiple spacer in conjunction with a second fluid, for the removal of oil/synthetic oil based mud cake and hydrocarbons prior to cementing or prior to introduction of a completion brine.

The present disclosure provides, in addition, a solvent system that is useful as a spearhead fluid for the removal of unwanted deposits or hydrocarbons prior to the introduction of a stimulation (or other well treatment) fluid.

Further, the present disclosure provides a solvent system that is of assistance in water control and as a breaker catalyst to decrease the viscosity of fracturing fluids and other gelled well treatment fluids upon lowering of the pH. Alternatively, the solvent system may function with enzyme breakers. As the pH of the solvent system is decreased, the enzymes are activated which causes a decrease in viscosity of the fracturing fluids or other gelled well treatment fluids.

The present disclosure provides a plant-based solvent system that is further useful in the displacement of synthetic and oil based drilling mud systems from the annulus and casing.

The system is further efficacious in the alleviation of water blocks, the removal of excess water and the lowering of pore pressure in the formation.

In a preferred mode, the solvent system is used to displace the drilling fluid with the completion fluid by being pumped into the well prior to introduction of packer fluid, when used. The solvent system has particular applicability in the removal of synthetic based oil muds (SOBM) and oil based drilling muds (OBM) from the wellbore casing, tubing and downhole liners in light of its ability to more readily break down emulsifiers and other additives present in the mud. In a particularly preferred embodiment of the disclosure, the solvent system is an emulsion used to remove OBM/SOBM drilling mud fluids. When used as an emulsion, the emulsifier should be selected according to whether oil or water based drilling fluids is used.

The system is further effective at decreasing the density of filter cakes during high pressure injection of gelled fluids into the wellbore.

The solvent system can be used for well remediation applications. In such applications, the solvent system is preferably injected directly into the wellbore through the production tubing or through the use of coiled tubing or similar delivery mechanisms. Once downhole, the well treatment solvent system remedies damage caused during well treating such as, for instance, by stimulation fluids and drilling fluid muds, by dispersing and removing fines, paraffin and/or asphaltene deposits, sulfur, pipe dope and unwanted hydrocarbons, such as heavy oil tar by-products and water blocks, from the formation and wellbore.

The solvent system can also be used for hydrogen sulfide mitigation. In a preferred embodiment, the solvent system is injected into the wellbore so that escaping hydrogen sulfide gas is “stripped” through the system. Preferably, the solvent system is periodically injected into problem wells to mitigate hydrogen sulfide production. Alternatively, the solvent system may be injected downhole via capillary tubing on a continuous basis. In yet another alternate embodiment, the solvent system may be placed in a container that is placed in fluid communication with the hydrogen sulfide. The interaction between the solvent system and the hydrogen sulfide neutralizes the enhancement of oil recovery and is useful in hydrogen sulfide, leaving an inert sulfur compound as a product of the reaction. Some or all of the water in the solvent system may further be replaced with a known hydrogen sulfide scavenger. For example, many cyclic amines, such as triazines and hexamines, can be used in combination with water to further improve hydrogen sulfide mitigation.

The well treatment solvent system can further be used in stimulation operations. In fracturing operations, for example, proppant material can be added to the system before injection downhole. The well treatment solvent system can also be used to deliver acids during acidizing operations. Acids commonly used include hydrochloric, acetic, formic, and hydrochloric-hydrofluoric acids.

Preferred embodiments of this disclosure are described below.

A composition comprising a blend of at least one C₁-C₄ ester of a C₁₆-C₂₀ fatty acid component, and at least one terpene hydrocarbon component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition comprising a blend of at least one C₁-C₄ ester of a C₁₆-C₂₀ fatty acid component, at least one terpene hydrocarbon component, and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition for cleaning a surface of a substrate. The composition comprises a blend of at least one C₁-C₄ ester of a C₁₆-C₂₀ fatty acid component, and at least one terpene hydrocarbon component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition for cleaning a surface of a substrate. The composition comprises a blend of at least one C₁-C₄ ester of a C₁₆-C₂₀ fatty acid component, at least one terpene hydrocarbon component, and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A cleaning composition comprising a blend of at least one C₁-C₄ ester of a C₁₆-C₂₀ fatty acid component, and at least one terpene hydrocarbon component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A cleaning composition comprising a blend of at least one C₁-C₄ ester of a C₁₆-C₂₀ fatty acid component, at least one terpene hydrocarbon component, and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition for treating an oil or gas well having a wellbore, well casing, production equipment, recovery equipment or transportation equipment. The composition comprises a blend of at least one C₁-C₄ ester of a C₁₆-C₂₀ fatty acid component, and at least one terpene hydrocarbon component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition for treating an oil or gas well having a wellbore, well casing, production equipment, recovery equipment or transportation equipment. The composition comprises a blend of at least one C₁-C₄ ester of a C₁₆-C₂₀ fatty acid component, at least one terpene hydrocarbon component, and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition for removing pipe dope, hydrocarbons, drilling muds, hydrogen sulfide, scales, fines, sulfur, heaving oil byproducts, water blocks, cement filtrates, kill fluids, paraffins and/or asphaltenes from surface equipment or downhole equipment. The composition comprises a blend of at least one C₁-C₄ ester of a C₁₆-C₂₀ fatty acid component, and at least one terpene hydrocarbon component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A composition removing pipe dope, hydrocarbons, drilling muds, hydrogen sulfide, scales, fines, sulfur, heaving oil byproducts, water blocks, cement filtrates, kill fluids, paraffins and/or asphaltenes from surface equipment or downhole equipment. The composition comprises a blend of at least one C₁-C₄ ester of a C₁₆-C₂₀ fatty acid component, at least one terpene hydrocarbon component, and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

The composition of paragraphs [0091], [0093], [0095], [0097] and [0099], further comprising at least one emulsifier component.

The composition of paragraphs [0091]-[00100], in which the weight percent ratio is such that the composition has a flash point greater than about 120° F.

The composition of paragraphs [0091]-[00100], wherein the at least one C₁-C₄ ester of a C₁₆-C₂₀ fatty acid component comprises at least one C₁-C₄ ester of corn oil, mustard oil, niger seed oil, olive oil, peanut oil, poppy seed oil, rapeseed oil, safflower oil, sesame oil, soybean oil, sunflower seed oil, wheat germ oil, or mixtures thereof.

The composition of paragraphs [0091]-[00100], wherein the at least one C₁-C₄ ester of a C₁₆-C₂₀ fatty acid component comprises a C₁₆-C₂₀ fatty acid methyl ester, or a soybean methyl ester.

The composition of paragraphs [0091]-[00100], wherein the at least one terpene hydrocarbon component comprises a pure gum turpentine, an oil of turpentine, or mixtures thereof.

The composition of paragraphs [0091]-[00100], wherein the at least one terpene hydrocarbon component comprises terpinolene, alpha-ocimene, beta-ocimene, alpha-terpinene, beta-terpinene, gamma-terpinene, sabinene, alpha-thujene, beta-thujene, camphene, carene, pinene, or mixtures thereof.

The composition of paragraphs [0091]-[00100], wherein the at least one terpene hydrocarbon component comprises pine oil, pinene, carene, menthadiene, dipentene, pine terpene, turpentine, a conifer terpene or resin, or mixtures thereof.

The composition of paragraphs [0091]-[00100], wherein the at least one terpene hydrocarbon component comprises pinene, a conifer terpene or resin, or mixtures thereof.

The composition of paragraphs [0091]-[00100], wherein the at least one C₁-C₄ ester of a C₁₆-C₂₀ fatty acid component comprises a soybean methyl ester, and the at least one terpene hydrocarbon component comprises pinene, a conifer terpene or resin, or mixtures thereof.

The composition of paragraphs [0091]-[00100], wherein the at least one terpene hydrocarbon component further comprises at least one terpenoid component.

The composition of paragraphs [0092], [0094], [0096], [0098], and[00100], wherein the at least one emulsifier component is anionic, nonionic, amphoteric, or mixtures thereof.

The composition of paragraphs [0092], [0094], [0096], [0098], and [00100], wherein the at least one emulsifier component is selected from the group consisting of polyoxyethylene sorbitan monopalmitate, polyoxyethylene sorbitan monostearate, polyoxyethylene sorbitan monooleate, linear alcohol alkoxylates, alkyl ether sulfates, linear nonyl-phenols, dioxane, ethylene glycol and ethoxylated castor oils such as polyethylene glycol castor oil, dipalmitoylphosphatidylcholine (DPPC), polyoxyethylene (8.6) nonyl phenyl ether, ethylene oxide sulfonates, alkyl propoxy-ethoxysulfate, alkylarylpropoxy-ethoxysulfonate and highly substituted benzene sulfonates.

The composition of paragraphs [0092], [0094], [0096], [0098], and [00100], wherein the at least one emulsifier component is a linear polyoxyethylene alcohol having from about 13 to about 15 carbon atoms and comprising about 8 to about 12 moles ethylene oxide.

The composition of paragraphs [0091]-[00100], further comprising at least one surfactant component.

The composition of paragraph [00114], wherein the at least one surfactant component is selected from the group consisting of an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, and combinations thereof.

The composition of paragraphs [0091]-[00100], wherein the weight percent ratio of the at least one C₁-C₄ ester of a C₁₆-C₂₀ fatty acid component to the at least one terpene hydrocarbon component is from about 40:60 weight percent to about 90:10 weight percent, based on the total weight of the composition.

The composition of paragraphs [0092], [0094], [0096], [0098] and [00100], wherein the at least one emulsifier is present in the composition in an amount from about 0.01 to about 10 percent by weight, based on the total weight of the composition.

The composition of paragraph [00114], wherein the at least one surfactant is present in the composition in an amount from about 0.01 to about 10 percent by weight, based on the total weight of the composition.

The composition of paragraphs [0091]-[00100] which forms an emulsion upon mixing with water.

The composition of paragraphs [0091]-[00100], which is used in a coating system.

The composition of paragraphs [00120], wherein the coating system is selected from paints, varnishes, lacquers, adhesives, and vinyl coatings.

A method of cleaning a surface of a substrate. The method comprises applying a cleaning composition comprising a solvent blend to a substrate surface having an undesirable residue thereupon, and removing the undesirable residue from the substrate surface. The solvent blend comprises at least one C₁-C₄ ester of a C₁₆-C₂₀ fatty acid component and at least one terpene hydrocarbon component (e.g., a pure gum turpentine, an oil of turpentine, or mixtures thereof). The weight percent ratio of the at least one C₁-C₄ ester of a C₁₆-C₁₆ fatty acid component to the at least one terpene hydrocarbon component is from about 10:90 weight percent to about 99:1 weight percent, based on the total weight of the solvent blend. The weight percent ratio is such that the solvent blend has a flash point greater than about 118° F.

A method of cleaning a surface of a substrate. The method comprises applying a cleaning composition comprising a solvent blend to a substrate surface having an undesirable residue thereupon, and removing the undesirable residue from the substrate surface. The solvent blend, when mixed with water, forms an emulsion. The solvent blend comprises at least one C₁-C₄ ester of a C₁₆-C₂₀ fatty acid component, at least one terpene hydrocarbon component (e.g., a pure gum turpentine, an oil of turpentine, or mixtures thereof), and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the solvent blend. The weight percent ratio is such that the solvent blend has a flash point greater than about 118° F.

A method of treating an oil or gas well having a wellbore, well casing, production equipment, recovery equipment or transportation equipment. The method comprises introducing into the wellbore, well casing, production equipment, recovery equipment or transportation equipment a solvent blend. The blend comprises at least one C₁-C₄ ester of a C₁₆-C₂₀ fatty acid component and at least one terpene hydrocarbon component (e.g., a pure gum turpentine, an oil of turpentine, or mixtures thereof). The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A method of treating an oil or gas well having a wellbore, well casing, production equipment, recovery equipment or transportation equipment. The method comprises introducing into the wellbore, well casing, production equipment, recovery equipment or transportation equipment a blend, which when mixed with water, forms an emulsion. The blend comprises a blend of at least one C₁-C₄ ester of a C₁₆-C₂₀ fatty acid component, at least one terpene hydrocarbon component (e.g., a pure gum turpentine, an oil of turpentine, or mixtures thereof), and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A method of removing pipe dope, hydrocarbons, drilling muds, hydrogen sulfide, scales, fines, sulfur, heaving oil byproducts, water blocks, cement filtrates, kill fluids, paraffins and/or asphaltenes from surface equipment or downhole equipment. The method comprises introducing onto the surface of the surface equipment or downhole equipment a solvent blend. The blend comprises at least one C₁-C₄ ester of a C₁₆-C₂₀ fatty acid component and at least one terpene hydrocarbon component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

A method of removing pipe dope, hydrocarbons, drilling muds, hydrogen sulfide, scales, fines, sulfur, heaving oil byproducts, water blocks, cement filtrates, kill fluids, paraffins and/or asphaltenes from surface equipment or downhole equipment. The method comprises introducing onto the surface of the surface equipment or downhole equipment a blend. The blend comprises a blend of at least one C₁-C₄ ester of a C₁₆-C₂₀ fatty acid component, at least one terpene hydrocarbon component, and at least one emulsifier component. The weight percent ratio of the at least one C₁-C₄ ester of a C₁₆-C₂₀ fatty acid component to the at least one terpene hydrocarbon component is from about 10:90 weight percent to about 99:1 weight percent, based on the total weight of the blend. The weight percent ratio is such that the blend has a flash point greater than about 118° F.

The method of paragraphs [00122], [00124] and [00126], wherein the blend further comprises at least one emulsifier component.

The method of paragraphs [00122]-[00127], in which the weight percent ratio is such that the blend has a flash point greater than about 120° F.

The method of paragraphs [00122]-[00127], wherein the at least one C₁-C₄ ester of a C₁₆-C₂₀fatty acid component comprises at least one C₁-C₄ ester of corn oil, mustard oil, niger seed oil, olive oil, peanut oil, poppy seed oil, rapeseed oil, safflower oil, sesame oil, soybean oil, sunflower seed oil, wheat germ oil, or mixtures thereof.

The method of paragraphs [00122]-[00127], wherein the at least one C₁-C₄ ester of a C₁₆-C₂₀ fatty acid component comprises a C₁₆-C₂₀ fatty acid methyl ester, or a soybean methyl ester.

The method of paragraphs [00122]-[00127], wherein the at least one terpene hydrocarbon component comprises a pure gum turpentine, an oil of turpentine, or mixtures thereof.

The method of paragraphs [00122]-[00127], wherein the at least one terpene hydrocarbon component comprises terpinolene, alpha-ocimene, beta-ocimene, alpha-terpinene, beta-terpinene, gamma-terpinene, sabinene, alpha-thujene, beta-thujene, camphene, carene, pinene, or mixtures thereof.

The method of paragraphs [00122]-[00127], wherein the at least one terpene hydrocarbon component comprises pine oil, pinene, carene, menthadiene, dipentene, pine terpene, turpentine, a conifer terpene or resin, or mixtures thereof.

The method of paragraphs [00122]-[00127], wherein the at least one terpene hydrocarbon component comprises pinene, a conifer terpene or resin, or mixtures thereof.

The method of paragraphs [00122]-[00127], wherein the at least one C₁-C₄ ester of a C₁₆-C₂₀fatty acid component comprises a soybean methyl ester, and the at least one terpene hydrocarbon component comprises pinene, a conifer terpene or resin, or mixtures thereof.

The method of paragraphs [00122]-[00127], wherein the at least one terpene hydrocarbon component further comprises at least one terpenoid component.

The method of paragraphs [00123], [00125], [00127] and [00128], wherein the at least one emulsifier component is anionic, nonionic, amphoteric, or mixtures thereof.

The method of paragraphs [00123], [00125], [00127] and [00128] wherein the at least one emulsifier component is selected from the group consisting of polyoxyethylene sorbitan monopalmitate, polyoxyethylene sorbitan monostearate, polyoxyethylene sorbitan monooleate, linear alcohol alkoxylates, alkyl ether sulfates, linear nonyl-phenols, dioxane, ethylene glycol and ethoxylated castor oils such as polyethylene glycol castor oil, dipalmitoylphosphatidylcholine (DPPC), polyoxyethylene (8.6) nonyl phenyl ether, ethylene oxide sulfonates, alkyl propoxy-ethoxysulfate, alkylarylpropoxy-ethoxysulfonate and highly substituted benzene sulfonates.

The method of paragraphs [00123], [00125], [00127] and [00128], wherein the at least one emulsifier component is a linear polyoxyethylene alcohol having from about 13 to about 15 carbon atoms and comprising about 8 to about 12 moles ethylene oxide.

The method of paragraphs [00122]-[00127], wherein the blend further comprises at least one surfactant component.

The method of paragraph [00141], wherein the at least one surfactant component is selected from the group consisting of an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, and combinations thereof.

The method of paragraphs [00122]-[00127], wherein the weight percent ratio of the at least one C₁-C₄ ester of a C₁₆-C₂₀ fatty acid component to the at least one terpene hydrocarbon component is from about 40:60 weight percent to about 90:10 weight percent, based on the total weight of the composition.

The method of paragraphs [00123], [00125], [00127] and [00128], wherein the at least one emulsifier is present in the composition in an amount from about 0.01 to about 10 percent by weight, based on the total weight of the composition.

The method of paragraphs [00141], wherein the at least one surfactant is present in the composition in an amount from about 0.01 to about 10 percent by weight, based on the total weight of the composition.

The method of paragraphs [00122]-[00127] in which an emulsion forms upon mixing with water.

The method of paragraphs [00122]-[00127], in which the blend is used in a coating system.

The method of paragraphs [00147], wherein the coating system is selected from paints, varnishes, lacquers, adhesives, and vinyl coatings

The method of paragraphs [00122]-[00127], which comprises introducing the blend into an oil or gas producing well penetrating a geological formation and stimulating the formation.

The method of paragraphs [00122]-[00127], wherein the blend further comprises at least one proppant.

The method of paragraphs [00122]-[00127], wherein, subsequent to introduction of the blend into the wellbore, well casing, production equipment, recovery equipment or transportation equipment, unwanted deposits are removed therefrom.

The method of paragraph [00151], wherein the unwanted deposits removed from the wellbore, well casing, production equipment, recovery equipment or transportation equipment are selected from the group consisting of asphaltenes, hydrogen sulfide, paraffins, scales, fines, sulfur, heavy oil by-products, water blocks, drilling fluids, cement filtrates, kill fluids, pipe dope, hydrocarbon emulsions, oil based muds and/or synthetic oil based muds.

The method of paragraphs [00122]-[00127], wherein the blend is introduced into the wellbore, well casing, production equipment, recovery equipment or transportation equipment through production or coiled tubing.

The method of paragraph [00122]-[00127], wherein the blend is introduced into the wellbore, well casing, production equipment, recovery equipment or transportation equipment and drilling muds are removed therefrom, and further wherein the drilling muds are removed prior to cementing of the wellbore or prior to introduction of a completion brine into the wellbore.

The method of paragraphs [00154], wherein the drilling muds are selected from the group consisting of oil based muds and synthetic oil based muds.

The method of paragraph [00122]-[00127], wherein the blend is introduced into the wellbore, well casing, production equipment, recovery equipment or transportation equipment which contains a well treating gelled fluid, and further wherein the blend, acting as a breaker catalyst, activates a gel breaker which is present in the wellbore, well casing, production equipment, recovery equipment or transportation equipment, thereby reducing the viscosity of the well treating gelled fluid.

The method of paragraphs [00122]-[00127], wherein the blend is a displacement spacer or a spearhead fluid.

The method of paragraphs [00122]-[00127], wherein the blend forms an emulsion upon mixing with water.

As used herein, “emulsions” include, for example, nanoemulsions, microemulsions, macroemulsions, and the like. The emulsions may be stable (i.e., permanent) or unstable (i.e., temporary).

As used herein, “hydrocarbons” include, for example, oil based muds, synthetic oil based muds, paraffins, asphaltenes, heavy oil byproducts, hydrocarbon emulsions, pipe dope, scales, fines, drilling fluids, cement filtrates, kill fluids, and the like.

The terms “comprises” or “comprising” are interpreted as specifying the presence of the stated features, integers, steps or components, but not precluding the presence of one or more other features, integers, steps or components or groups thereof.

It should be understood that various alternatives, combinations and modifications of the present disclosure could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The following examples are provided to offer additional description of the compositions and methods disclosed and claimed in this patent. These are exemplary only, and are not intended to limit the disclosure in any aspect. All proportions and percentages set out herein are by weight unless the contrary is stated.

What is claimed is:

1. A composition consisting essentially of:
a blend of at least one C₁-C₄ ester of a C₁₆-C₂₀ fatty acid component, and at least one terpene hydrocarbon component; and optionally one or more of an emulsifier, a surfactant, a thixotropic agent, a pH adjuster, an alcohol, a salt, an acid, and water;
wherein the at least one C₁-C₄ ester of a C₁₆-C₂₀ fatty acid component is selected from at least one C₁-C₄ ester of corn oil, mustard oil, niger seed oil, olive oil, peanut oil, poppy seed oil, rapeseed oil, safflower oil, sesame oil, soybean oil, sunflower seed oil, wheat germ oil, or mixtures thereof;
wherein the weight percent ratio of the at least one C₁-C₄ ester of a C₁₆-C₂₀ fatty acid component to the at least one terpene hydrocarbon component is from about 10:90 weight percent to about 90:10 weight percent, based on the total weight of the composition; and
wherein the weight percent ratio is such that the composition has a flash point greater than about 118° F.

2. The composition of claim 1, wherein the blend further comprises at least one emulsifier.

3. The composition of claim 1, wherein the weight percent ratio is such that the blend has a flash point greater than about 120° F.

4. The composition of claim 1, wherein the at least one C₁-C₄ ester of a C₁₆-C₂₀ fatty acid component comprises a C₁₆-C₂₀ fatty acid methyl ester, or a soybean methyl ester.

5. The composition of claim 1, wherein the at least one terpene hydrocarbon component comprises a pure gum turpentine, an oil of turpentine, or mixtures thereof.

6. The composition of claim 1, wherein the at least one terpene hydrocarbon component comprises terpinolene, alpha-ocimene, beta-ocimene, alpha-terpinene, beta-terpinene, gamma-terpinene, sabinene, alpha-thujene, beta-thujene, camphene, carene, pinene, or mixtures thereof.

7. The composition of claim 1, wherein the at least one terpene hydrocarbon component comprises pine oil, pinene, carene, menthadiene, dipentene, pine terpene, turpentine, a conifer terpene or resin, or mixtures thereof.

8. The composition of claim 1, wherein the at least one terpene hydrocarbon component comprises pinene, a conifer terpene or resin, or mixtures thereof.

9. The composition of claim 1, wherein the at least one C₁-C₄ ester of a C₁₆-C₂₀ fatty acid component comprises a soybean methyl ester, and the at least one terpene hydrocarbon component comprises pinene, a conifer terpene or resin, or mixtures thereof.

10. The composition of claim 1, wherein the at least one terpene hydrocarbon component further comprises at least one terpenoid component.

11. The composition of claim 2, wherein the at least one emulsifier component is anionic, nonionic, amphoteric, or mixtures thereof.

12. The composition of claim 2, wherein the at least one emulsifier component is selected from the group consisting of polyoxyethylene sorbitan monopalmitate, polyoxyethylene sorbitan monostearate, polyoxyethylene sorbitan monooleate, linear alcohol alkoxylates, alkyl ether sulfates, linear nonyl-phenols, dioxane, ethylene glycol and ethoxylated castor oils such as polyethylene glycol castor oil, dipalmitoylphosphatidylcholine (DPPC), polyoxyethylene (8.6) nonyl phenyl ether, ethylene oxide sulfonates, alkyl propoxy-ethoxysulfate, alkylarylpropoxy-ethoxysulfonate and highly substituted benzene sulfonates.

13. The composition of claim 2, wherein the at least one emulsifier component is a linear polyoxyethylene alcohol having from about 13 to about 15 carbon atoms and comprising about 8 to about 12 moles ethylene oxide.

14. The composition of claim 1, wherein the blend further comprises at least one surfactant.

15. The composition of claim 14, wherein the at least one surfactant is selected from the group consisting of an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, and combinations thereof.

16. The composition of claim 1, wherein the weight percent ratio of the at least one C₁-C₄ ester of a C₁₆-C₂₀ fatty acid component to the at least one terpene hydrocarbon component is from about 40:60 weight percent to about 90:10 weight percent, based on the total weight of the blend.

17. The composition of claim 2, wherein the at least one emulsifier is present in the blend in an amount from about 0.01 to about 10 percent by weight, based on the total weight of the blend.

18. The composition of claim 14, wherein the at least one surfactant is present in the blend in an amount from about 0.01 to about 10 percent by weight, based on the total weight of the blend.

19. The composition of claim 1, which is used in a coating system.

20. The composition of claim 19, wherein the coating system is selected from paints, varnishes, lacquers, adhesives, and vinyl coatings.
